(19) United States
(12) Patent Application Publication
(10) Pub. No.: US 2024/0047648 A1
(43) Pub. Date: Feb. 8, 2024

(54) BATTERY AND METHOD FOR MANUFACTURING BATTERY

(71) Applicant: Panasonic Intellectual Property Management Co., Ltd., Osaka (JP)

(72) Inventors: YUSUKE ITO, Nara (JP); SHUJI ITO, Nara (JP); TADAAKI MATSUMURA, Shiga (JP)

(21) Appl. No.: 18/487,160

(22) Filed: Oct. 16, 2023

Related U.S. Application Data
(63) Continuation of application No. PCT/JP2022/001885, filed on Jan. 20, 2022.

(30) Foreign Application Priority Data
May 17, 2021 (JP) 2021-083433

(51) Int. Cl. H01M 4/134; H01M 4/38; H01M 4/66; H01M 10/0562; H01M 10/0585; H01M 4/1395; H01M 4/04

(52) U.S. Cl. CPC H01M 4/134; H01M 4/386; H01M 4/661; H01M 10/0562; H01M 10/0585; H01M 4/1395; H01M 4/0404; H01M 4/0471; H01M 2004/027

(57) ABSTRACT

A battery according to an aspect of the present disclosure includes a positive electrode, a negative electrode, and an electrolyte layer located between the positive electrode and the negative electrode. The negative electrode includes a negative electrode current collector and a negative electrode active material layer located between the negative electrode current collector and the electrolyte layer. The negative electrode active material layer has a plurality of columnar bodies containing silicon as a primary component. Young's modulus of the negative electrode active material layer is less than or equal to 25 GPa.

### BACKGROUND

### 1. Technical Field

The present disclosure relates to a battery and a method for manufacturing the battery.

### 2. Description of the Related Art

International Publication No. 2017/073585 discloses a battery including a negative electrode containing a negative electrode active material that contains silicon and that has a hardness of greater than or equal to 10 GPa and less than or equal to 20 GPa.

### SUMMARY

Regarding the related art, it is desirable that compatibility between the capacity and the cycle characteristics be ensured.

In one general aspect, the techniques disclosed here feature a battery including a positive electrode, a negative electrode, and an electrolyte layer located between the positive electrode and the negative electrode, wherein the negative electrode includes a negative electrode current collector and a negative electrode active material layer located between the negative electrode current collector and the electrolyte layer, the negative electrode active material layer has a plurality of columnar bodies containing silicon as a primary component, and Young's modulus of the negative electrode active material layer is less than or equal to 25 GPa.

According to the present disclosure, a battery that ensures compatibility between the capacity and the cycle characteristics is realized.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided to obtain one or more of such benefits and/or advantages.

### BRIEF DESCRIPTION OF THE DRAWINGS

FIG. 1 is a schematic sectional view illustrating a configuration of a battery according to a first embodiment;

FIG. 2 is an example of an SEM image of a cross section of a negative electrode according to the first embodiment;

FIG. 3 is an SEM image of a cross section of a negative electrode in a charged state according to Example 1; and

FIG. 4 is an SEM image of a cross section of a negative electrode in a charged state according to Comparative example 1.

### DETAILED DESCRIPTIONS

### Underlying Knowledge Forming Basis of the Present Disclosure

To address the rapid spread of electric vehicles (EV), development of a car-mounted lithium secondary battery having features such as high safety, high performance, and a long life is an urgent necessity. In addition, to improve the convenience in using EV, an increase in the cruising range per charge and a decrease in the charge time are desired. To enable the lithium secondary battery to have a high energy density or to enable the lithium secondary battery to have a high capacity, it is important to develop a negative electrode material having a high capacity. For example, silicon is a potential material for the negative electrode material having a high capacity. However, a silicon negative electrode having excellent capacity and excellent cycle characteristics in combination has not been obtained.

International Publication No. 2017/073585 discloses a lithium secondary battery including a negative electrode containing a negative electrode active material that contains silicon and that has a hardness of greater than or equal to 10 GPa and less than or equal to 20 GPa. International Publication No. 2017/073585 discloses that silicon and a dissimilar metal element such as aluminum form an intermetallic compound. In addition, International Publication No. 2017/073585 discloses that the mass ratio of silicon to the dissimilar metal element is 50:50 to 90:10.

Regarding International Publication No. 2017/073585, the dissimilar metal element that does not function as a power generation factor of a battery is contained in the negative electrode active material in a large proportion of 10% to 50%. In this regard, since silicon and the dissimilar metal element form an intermetallic compound, the capacity provided to silicon is not sufficiently realized.

The present inventors performed intensive research on a battery having the capacity and the cycle characteristics in combination. As a result, it was found that when the negative electrode active material layer has a plurality of columnar bodies containing silicon as a primary component and Young's modulus of the negative electrode active material layer is less than or equal to 25 GPa, a battery ensuring compatibility between the capacity and the cycle characteristics can be realized. The reason for this is as described below. When Young's modulus of the negative electrode active material layer is less than or equal to 25 GPa, the deformability of the negative electrode active material layer is improved. Therefore, in accordance with expansion of the negative electrode during the first charge of the battery, a gap between adjacent columnar bodies is decreased, and, in addition, the surface of the columnar body is smoothened along the surface of the electrolyte layer opposite the negative electrode. Consequently, an interface having a large contact area is formed between the negative electrode active material layer and the electrolyte layer. Accordingly, the negative electrode active material layer can continue to hold the smooth interface against the electrolyte layer while maintaining a dense columnar structure regardless of expansion and shrinkage potentially resulting from charge and discharge thereafter. As a result, a battery that ensures compatibility between the capacity and the cycle characteristics is realized.

### Outline of Aspect According to Present Disclosure

A battery according to a first aspect of the present disclosure includes:
a positive electrode;
a negative electrode; and
an electrolyte layer located between the positive electrode and the negative electrode,
wherein the negative electrode includes a negative electrode current collector and a negative electrode active material layer located between the negative electrode current collector and the electrolyte layer,
the negative electrode active material layer has a plurality of columnar bodies containing silicon as a primary component, and
Young's modulus of the negative electrode active material layer is less than or equal to 25 GPa.

According to the above-described configuration, in accordance with expansion of the negative electrode during the first charge of the battery, a gap between adjacent columnar bodies is decreased, and, in addition, the surface of the columnar body is smoothened along the surface of the electrolyte layer opposite the negative electrode. Consequently, an interface having a large contact area is formed between the negative electrode active material layer and the electrolyte layer. As a result, a battery that ensures compatibility between the capacity and the cycle characteristics is realized.

Regarding a second aspect of the present disclosure, for example, in the battery according to the first aspect, Young's modulus of the negative electrode active material layer may be less than or equal to 20 GPa. According to the above-described configuration, the deformability of the negative electrode active material layer is further improved. Consequently, an interface having a large contact area is more readily formed between the negative electrode active material layer and the electrolyte layer during the first charge of the battery.

Regarding a third aspect of the present disclosure, for example, in the battery according to the first aspect, a thickness of the negative electrode active material layer may be less than or equal to 30 μm. According to the above-described configuration, the battery can be operated with high input and output.

Regarding a fourth aspect of the present disclosure, for example, in the battery according to the first aspect, the negative electrode current collector may contain copper as a primary component. According to the above-described configuration, there are advantages in suppression of the internal resistance of the battery.

Regarding a fifth aspect of the present disclosure, for example, in the battery according to the first aspect, the negative electrode active material layer may contain 1% or less by mass of copper. According to the above-described configuration, the capacity of the battery can be suppressed from decreasing.

Regarding a sixth aspect of the present disclosure, for example, in the battery according to the first aspect, the electrolyte layer may contain a solid electrolyte having lithium-ion conductivity. According to the above-described configuration, a battery that ensures compatibility between the capacity and the cycle characteristics can be more reliably realized.

Regarding a seventh aspect of the present disclosure, for example, in the battery according to the sixth aspect, the solid electrolyte may contain a sulfide solid electrolyte. According to the above-described configuration, the output characteristics of the battery can be further improved.

A battery according to an eighth aspect of the present disclosure includes:
a positive electrode;
a negative electrode; and
an electrolyte layer located between the positive electrode and the negative electrode,
wherein the negative electrode includes a negative electrode current collector and a negative electrode active material layer located between the negative electrode current collector and the electrolyte layer,
the negative electrode active material layer contains silicon and 1% or less by mass of copper, and
Young's modulus of the negative electrode active material layer is less than or equal to 25 GPa.

According to the above-described configuration, the deformability of the negative electrode active material layer is improved. Consequently, an interface having a large contact area is formed between the negative electrode active material layer and the electrolyte layer. As a result, a battery that ensures compatibility between the capacity and the cycle characteristics is realized.

Regarding a ninth aspect of the present disclosure, for example, in the battery according to the eighth aspect, the negative electrode active material layer may have a plurality of columnar bodies containing silicon as a primary component. According to the above-described configuration, in accordance with expansion of the negative electrode during the first charge of the battery, a gap between adjacent columnar bodies is decreased, and, in addition, the surface of the columnar body is smoothened along the surface of the electrolyte layer opposite the negative electrode. Consequently, an interface having a large contact area is formed between the negative electrode active material layer and the electrolyte layer. As a result, a battery that ensures compatibility between the capacity and the cycle characteristics can be more reliably realized.

Regarding a tenth aspect of the present disclosure, for example, in the battery according to the eighth aspect, Young's modulus of the negative electrode active material layer may be less than or equal to 20 GPa. According to the above-described configuration, the deformability of the negative electrode active material layer is further improved. Consequently, an interface having a large contact area is more readily formed between the negative electrode active material layer and the electrolyte layer during the first charge of the battery.

Regarding an eleventh aspect of the present disclosure, for example, in the battery according to the eighth aspect, a thickness of the negative electrode active material layer may be less than or equal to 30 μm. According to the above-described configuration, the battery can be operated with high input and output.

Regarding a twelfth aspect of the present disclosure, for example, in the battery according to the eighth aspect, the negative electrode current collector may contain copper as a primary component. According to the above-described configuration, there are advantages in suppression of the internal resistance of the battery.

Regarding a thirteenth aspect of the present disclosure, for example, in the battery according to the eighth aspect, the electrolyte layer may contain a solid electrolyte having lithium-ion conductivity. According to the above-described configuration, a battery that ensures compatibility between the capacity and the cycle characteristics can be more reliably realized.

Regarding a fourteenth aspect of the present disclosure, for example, in the battery according to the thirteenth aspect, the solid electrolyte may contain a sulfide solid electrolyte. According to the above-described configuration, the output characteristics of the battery can be further improved.

A method for manufacturing a battery according to a fifteenth aspect of the present disclosure includes:
depositing silicon on a negative electrode current collector by a gas phase method, and
annealing the deposited silicon at a temperature of lower than or equal to 300° C.

According to the above-described configuration, a battery including a negative electrode in which the negative electrode active material layer has a plurality of columnar bodies containing silicon as a primary component and Young's modulus of the negative electrode active material layer is less than or equal to 25 GPa can be manufactured. Consequently, a battery that ensures compatibility between the capacity and the cycle characteristics can be realized.

Regarding a sixteenth aspect of the present disclosure, for example, in the method for manufacturing a battery according to the fifteenth aspect, a time of the annealing may be greater than or equal to 5 hours and less than or equal to 30 hours. According to the above-described configuration, a battery including a negative electrode in which the negative electrode active material layer has a plurality of columnar bodies containing silicon as a primary component and Young's modulus of the negative electrode active material layer is less than or equal to 25 GPa can be more reliably manufactured.

The embodiment according to the present disclosure will be described below with reference to the drawings.

### First Embodiment

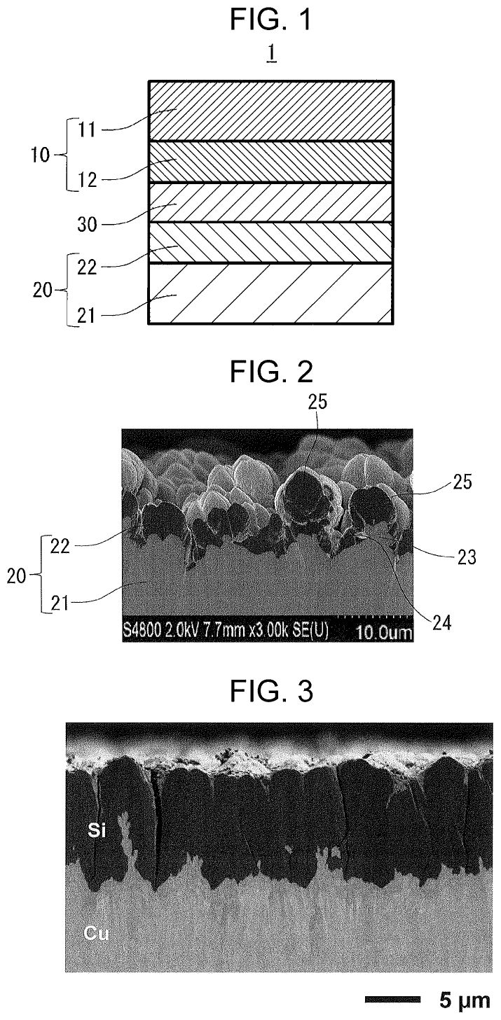

FIG. 1 is a schematic sectional view illustrating a configuration of a battery 1 according to a first embodiment.

The battery 1 according to the first embodiment includes a positive electrode 10, a negative electrode 20, and an electrolyte layer 30 located between the positive electrode 10 and the negative electrode 20. The negative electrode 20 includes a negative electrode current collector 21 and a negative electrode active material layer 22 located between the negative electrode current collector 21 and the electrolyte layer 30.

The negative electrode active material layer 22 has a plurality of columnar bodies containing silicon as a primary component. Silicon serves as a negative electrode active material. Young's modulus of the negative electrode active material layer 22 is less than or equal to 25 GPa. In the present disclosure, “primary component” denotes a component contained in the largest mass ratio.

FIG. 2 is an example of a scanning electron microscope (SEM) image of a cross section of the negative electrode 20. As illustrated in FIG. 2, the negative electrode active material layer 22 has a plurality of columnar bodies containing silicon as a primary component. The negative electrode current collector 21 has a plurality of protruded portions 23 and a plurality of recessed portions 24 on one surface. Each of the plurality of columnar bodies 25 is supported by the protruded portion 23. The plurality of columnar bodies 25 are formed extending outward from the one surface of the negative electrode current collector 21 and having spaces therebetween.

When Young's modulus of the negative electrode active material layer 22 is less than or equal to 25 GPa, the deformability of the negative electrode active material layer 22 is improved. Therefore, in accordance with expansion of the negative electrode 20 during the first charge of the battery 1, a gap between adjacent columnar bodies 25 is decreased, and, in addition, the surface of the columnar body 25 is smoothened along the surface of the electrolyte layer 30 opposite the negative electrode 20. Consequently, an interface having a large contact area is formed between the negative electrode active material layer 22 and the electrolyte layer 30. Accordingly, the negative electrode active material layer 22 can continue to hold the interface against the electrolyte layer 30 while maintaining a dense columnar structure regardless of expansion and shrinkage potentially resulting from charge and discharge thereafter. As a result, a battery 1 that ensures compatibility between the capacity and the cycle characteristics is realized.

Young's modulus of the negative electrode active material layer 22 can be measured by using, for example, a nanoindentation method. Specifically, Young's modulus is measured with respect to 12 arbitrarily selected points on the surface of the negative electrode active material layer 22 by using a nanoindentation apparatus. Of these data, the minimum value and the maximum value are excluded in consideration of measurement errors due to unevenness of the surface of the negative electrode active material layer 22, and Young's modulus is determined by calculating an average value of the resulting 10 points.

FIG. 2 illustrates an uncharged and annealed negative electrode active material layer 22. Young's modulus is measured with respect to the uncharged and annealed negative electrode active material layer 22. In this regard, even when the battery 1 is charged and discharged, Young's modulus of the negative electrode active material layer 22 is substantially maintained at a value before charge and discharge.

Young's modulus of the negative electrode active material layer 22 may be less than or equal to 20 GPa. According to the above-described configuration, the deformability of the negative electrode active material layer 22 is further improved. Consequently, during the first charge of the battery 1, an interface having a large contact area is more readily formed between the negative electrode active material layer 22 and the electrolyte layer 30. There is no particular limitation regarding the lower limit value of Young's modulus of the negative electrode active material layer 22. The lower limit value is, for example, 10 GPa.

The negative electrode active material layer 22 contains silicon as a primary component and, in addition, contains copper. According to the above-described configuration, the ion conductivity of the negative electrode active material layer 22 can be improved.

It is considered that the electron conductivity of a negative electrode active material layer containing only silicon is low. On the other hand, the negative electrode active material layer 22 according to the present disclosure contains silicon and copper. In general, copper does not form an alloy with lithium. Therefore, it is considered that copper does not have lithium-ion conductivity. However, the electron conductivity of the negative electrode active material layer 22 is greater than the electron conductivity of a negative electrode active material layer containing only silicon due to the negative electrode active material layer 22 containing silicon and copper.

The negative electrode active material layer 22 contains 1% or less by mass of copper. Copper does not function as a power generation factor of the battery 1. Consequently, the negative electrode active material layer 22 containing 1% or less by mass of copper enables the capacity of the battery 1 to be suppressed from decreasing.

The mass ratio of copper contained in the negative electrode active material layer 22 can be determined by using, for example, secondary ion mass spectrometry (SIMS). Specifically, with respect to each of the copper element and the silicon element in the negative electrode 20, the concentration distribution in the thickness direction is obtained by using a secondary ion mass spectrometer. The concentration of each element can be calculated as a value obtained by dividing the integrated value of the respective concentration distribution in the negative electrode active material layer 22 by the thickness of the negative electrode active material layer 22. The thus calculated concentration of the copper element is denoted as C1, and the concentration of the silicon element is denoted as C2. C1/(C1+C2) can be assumed to be the mass ratio of copper contained in the negative electrode active material layer 22. In this regard, in the resulting concentration distribution, the interface between the negative electrode active material layer 22 and the negative electrode current collector 21 can be identified as a portion having a higher concentration of the element than the other portion or a portion having a lower concentration of the element than the other portion.

Copper contained in the negative electrode active material layer 22 is not present in the state of a simple substance or an intermetallic compound with silicon. Copper contained in the negative electrode active material layer 22 diffuses on the order of ppm in the negative electrode active material layer 22 and is present in the state of a solid solution formed with silicon. According to the above-described configuration, Young's modulus of the negative electrode active material layer 22 is readily decreased to 25 GPa or less.

Copper contained in the negative electrode active material layer 22 being present in the state of a solid solution formed with silicon can be identified by, for example, a peak profile analysis method using X-ray diffraction or a structure observation method using a transmission electron microscope (TEM).

The thickness of the negative electrode active material layer 22 may be less than or equal to 30 μm. The thickness of the negative electrode active material layer 22 being less than or equal to 30 μm enables risks such as film cracking during film formation by sputtering or during handling in the annealing thereafter to be decreased. Consequently, the battery 1 can be operated with high input and output.

The thickness of the negative electrode active material layer 22 can be measured by a method described below. A cross section of the negative electrode active material layer 22 is observed by using a scanning electron microscope (SEM). The cross section is a cross section parallel to the laminating direction of the layers and is a cross section including the center of gravity of the negative electrode active material layer 22 in plan view. Twenty arbitrary points in the resulting SEM image of the cross section are selected. The thickness of the negative electrode active material layer 22 is measured at the 20 arbitrarily selected points. The average value of the measured values thereof is assumed to be the thickness.

There is no particular limitation regarding the lower limit value of the thickness of the negative electrode active material layer 22. The thickness of the negative electrode active material layer 22 may be greater than or equal to 5 μm. When the thickness of the negative electrode active material layer 22 is greater than or equal to 5 μm, the energy density of the battery 1 is readily ensured.

The negative electrode active material layer 22 may contain amorphous silicon. In the present disclosure, “amorphous” is not limited to denoting a substance having no crystal structure at all and includes a substance having a crystalline region within a short range order. An amorphous substance is, for example, a substance that does not exhibit a sharp peak derived from a crystal in X-ray diffraction (XRD) but that does exhibit a broad peak derived from an amorphous substance. In the present disclosure, “contain amorphous silicon” denotes that at least a portion of the negative electrode active material layer 22 contains silicon. From the viewpoint of lithium-ion conductivity, silicon contained in the negative electrode active material layer 22 may be entirely amorphous.

The negative electrode active material layer 22 is not limited to containing crystalline silicon. Silicon contained in the negative electrode active material layer 22 may be composed of substantially amorphous silicon and may be composed of only amorphous silicon. For example, when the negative electrode active material layer 22 is a thin film, the XRD measurement is performed at a plurality of arbitrary positions on the thin film. In such an instance, when a sharp peak is not observed at any position, it may be determined that silicon contained in the negative electrode active material layer 22 is entirely amorphous silicon, is composed of substantially amorphous silicon, or contains only amorphous silicon.

The negative electrode current collector 21 contains copper as a primary component. According to the above-described configuration, there are advantages in suppression of the internal resistance of the battery 1.

The ratio of the mass of copper to the mass of the negative electrode current collector 21 may be greater than or equal to 70% by mass and less than or equal to 100% by mass and may be greater than or equal to 85% by mass and less than or equal to 95% by mass.

The negative electrode current collector 21 may be composed of substantially only copper. In the present disclosure, “substantially” denotes that incidental impurities which are unintentionally mixed are excluded. According to the above-described configuration, there are advantages in suppression of the internal resistance of the battery 1.

Regarding the negative electrode current collector 21, for example, electrolytic copper foil having a roughened surface due to copper being precipitated by an electrolytic method may be used. Regarding the negative electrode current collector 21, copper alloy foil having a roughened surface due to copper being precipitated on the surface of rolled copper alloy foil by an electrolytic method may be used.

The thickness of the negative electrode current collector 21 may be, for example, greater than or equal to 5 μm and less than or equal to 50 μm and may be greater than or equal to 8 μm and less than or equal to 25 μm.

The electrolyte layer 30 is a layer containing an electrolyte. The electrolyte is, for example, a solid electrolyte. That is, the electrolyte layer 30 may be a solid electrolyte layer.

The electrolyte layer 30 may contain a solid electrolyte having lithium-ion conductivity. According to the above-described configuration, a battery 1 that ensures compatibility between the capacity and the cycle characteristics can be more reliably realized.

Examples of the solid electrolyte contained in the electrolyte layer 30 include sulfide solid electrolytes, oxide solid electrolytes, halide solid electrolytes, complex hydride solid electrolytes, and polymer solid electrolytes. According to the above-described configuration, the output characteristics of the battery 1 can be improved.

The solid electrolyte contained in the electrolyte layer 30 may include a sulfide solid electrolyte. According to the above-described configuration, the output characteristics of the battery 1 can be further improved.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MOₚ, or Li_{q}MOᵣ may be added to these solid electrolytes. X contains at least one selected from the group consisting of F, Cl, Br, and I. M is at least one selected from the group consisting of P, Si, Ge, B, Al, Ga, In, Fe, and Zn. Each of p, q, and r is a natural number.

Examples of the oxide solid electrolyte include NASICON-type solid electrolytes represented by LiTi₂(PO₄)₃ and element-substituted products thereof, perovskite-type solid electrolytes containing (LaTi)TiO₃, LISICON-type solid electrolytes represented by Li₁₄ZnGe₄O₁₆, Li₄SiO₄, and LiGeO₄ and element-substituted products thereof, garnet-type solid electrolytes represented by Li₇La₃Zr₂O₁₂ and element-substituted products thereof, Li₃N and H-substituted products thereof, Li₃PO₄ and N-substituted products thereof, and glass or glass ceramics in which a Li—B—O compound such as LiBO₂ or Li₃BO₃ serves as a base and Li₂SO₄, Li₂ CO₃, or the like is added.

Examples of the halide solid electrolytes include materials denoted by a composition formula Li_{α}M_{β}X_{γ}. Each of α, β, and γ is a value greater than 0. M includes at least one selected from the group consisting of metal elements other than Li and semi-metal elements. X is at least one element selected from the group consisting of F, Cl, Br, and I. In this regard, the semi-metal elements are B, Si, Ge, As, Sb, and Te. The metal elements are all elements except hydrogen of group I to group XII of the periodic table and all elements except B, Si, Ge, As, Sb, Te, C, N, P, O, S, and Se of group XIII to group XVI of the periodic table. That is, semi-metal elements or metal elements are element groups which can become cations when an inorganic compound is formed with a halogen compound.

Specific examples of the halide solid electrolytes include Li₃YX₆, Li₂MgX₄, Li₂FeX₄, Li(Al, Ga, In)X₄, and Li₃(Al, Ga, In)X₆. In the present disclosure, “(Al, Ga, In)” denotes at least one element selected from the group consisting of the elements in parentheses. That is, “(Al, Ga, In)” is synonymous with “at least one selected from the group consisting of Al, Ga, and In”. The same applies to other elements.

Examples of the complex hydride solid electrolyte include LiBH₄—LiI and LiBH₄—P₂S₅.

Examples of the polymer solid electrolyte include compounds of polymer compounds and lithium salts. The polymer compound may have an ethylene oxide structure. The polymer compound having the ethylene oxide structure enables a large amount of lithium salt to be contained and enables the ion conductivity to be further increased. Examples of the lithium salt include LiPF₆, LiBF₄, LiSbF₆, LiAsF₆, LiSO₃ CF₃, LiN(SO₂ CF₃)₂, LiN(SO₂ C₂F₅)₂, LiN(SO₂ CF₃)(SO₂ C₄F₉), and LiC(SO₂ CF₃)₃. Regarding the lithium salt, at least one selected from the group consisting of the above-described lithium salts may be used alone. Alternatively, regarding the lithium salt, a mixture of at least two selected from the group consisting of the above-described lithium salts may be used.

The electrolyte layer 30 may contain only one solid electrolyte selected from the materials mentioned as the solid electrolyte.

The electrolyte layer 30 may contain two or more solid electrolytes selected from the materials mentioned as the solid electrolyte. In such an instance, the plurality of solid electrolytes have compositions that differ from each other. For example, the electrolyte layer 30 may contain the halide solid electrolyte and the sulfide solid electrolyte.

The positive electrode 10 includes a positive electrode current collector 11 and a positive electrode active material layer 12. The positive electrode active material layer 12 is located between the positive electrode current collector 11 and the electrolyte layer 30.

The material for forming the positive electrode current collector 11 is not limited to a specific material, and materials commonly used for a battery can be used. Examples of the material for forming the positive electrode current collector 11 include copper, copper alloys, aluminum, aluminum alloys, stainless steel, nickel, titanium, carbon, lithium, indium, and electroconductive resins. The shape of the positive electrode current collector 11 is not limited to a specific shape. Examples of the shape include foil, a film, and a sheet. The surface of the positive electrode current collector 11 may be provided with unevenness.

The positive electrode active material layer 12 contains, for example, a positive electrode active material. The positive electrode active material contains, for example, a material having characteristics to occlude and release metal ions such as a lithium ion. Examples of the positive electrode active material include lithium-containing transition metal oxides, transition metal fluorides, polyanion materials, polyanion fluoride materials, transition metal sulfides, transition metal oxy-sulfides, and transition metal oxynitrides. Examples of the lithium-containing transition metal oxide include Li(Ni, Co, Al)O₂, Li(Ni, Co, Mn)O₂, and LiCoO₂. In particular, when the lithium-containing transition metal oxide is used as the positive electrode active material, the manufacturing cost can be decreased, and an average discharge voltage can be increased. To increase the energy density of the battery, the positive electrode active material may contain nickel cobalt manganese acid lithium. The positive electrode active material may be, for example, Li(Ni, Co, Mn)O₂.

The area of the main surface of the battery 1 is, for example, greater than or equal to 1 cm² and less than or equal to 100 cm². In such an instance, the battery 1 can be used for, for example, portable electronic apparatuses such as smartphones and digital cameras. Alternatively, the area of the main surface of the battery 1 may be, for example, greater than or equal to 100 cm² and less than or equal to 1,000 cm². In such an instance, the battery 1 can be used for, for example, power supplies of large mobile apparatuses such as electric vehicles. Here, “main surface” denotes a surface having the largest area in the battery 1.

### Method for Manufacturing Battery

The battery 1 according to the present embodiment may be produced by, for example, a method described below.

For example, electrolytic copper foil having a roughened surface due to copper being precipitated by an electrolytic method is used as the negative electrode current collector 21.

The electrolytic copper foil can be obtained as described below. Initially, a metal drum is immersed in an electrolytic solution in which a copper ion is dissolved. Copper is precipitated on the surface of the drum by passing a current while the drum is rotated. The electrolytic copper foil can be obtained by peeling the copper precipitated on the surface of the drum. One surface or both surfaces of the electrolytic copper foil may be subjected to roughening treatment or surface treatment.

Thereafter, silicon is deposited on the negative electrode current collector 21 to form a silicon thin film. Consequently, a plurality of columnar bodies 25 containing silicon as a primary component are formed on the negative electrode current collector 21.

Examples of the method for forming the plurality of columnar bodies 25 containing silicon as a primary component include a chemical vapor deposition (CVD) method, a sputtering method, a vapor deposition method, a thermal spraying method, and a plating method. Of these, vapor phase methods, such as a CVD method, a sputtering method, and a vapor deposition method, may be adopted from the viewpoint of adhesiveness to the negative electrode current collector 21 and suppression of surface oxidation. Copper is an element which readily diffuses in silicon. Therefore, in particular, when copper is used as the negative electrode current collector 21, there are effects of improving adhesiveness between copper and silicon and suppressing the silicon-copper interface from expanding during charge.

Finally, the resulting silicon thin film is annealed at a temperature of lower than or equal to 300° C. Consequently, the negative electrode 20 is produced.

Silicon forms an intermetallic compound with copper in a high-temperature region. The silicon thin film being annealed at a low temperature of lower than or equal to 300° C. enables silicon and a dissimilar metal element to be suppressed from forming an intermetallic compound. Consequently, the capacity provided to silicon can be sufficiently realized.

In addition, the silicon thin film being annealed at a low temperature of lower than or equal to 300° C. enables copper to be suppressed from diffusing in the negative electrode active material layer 22. Consequently, since copper contained in the negative electrode active material layer 22 can be decreased to less than or equal to 1% by mass, the capacity of the battery 1 can be suppressed from decreasing.

The annealing temperature of the silicon thin film may be lower than or equal to 250° C. and may be lower than or equal to 200° C. There is no particular limitation regarding the lower limit value of the annealing temperature of the silicon thin film. The annealing temperature of the silicon thin film may be, for example, higher than or equal to 100° C.

The annealing time of the silicon thin film is, for example, greater than or equal to 5 hours and less than or equal to 30 hours. The annealing time of the silicon thin film may be greater than or equal to 10 hours and less than or equal to 20 hours.

Examples of the shape of the battery 1 according to the first embodiment include a coin type, a cylindrical type, a rectangular type, a sheet type, a button type, a flat type, and a multilayer type.

### EXAMPLES

The present disclosure will be described below in detail with reference to the example and the comparative example. The example below is an exemplification, and the present disclosure is not limited to the example below.

### Example 1

### Production of Negative Electrode

Electrolytic copper foil having a roughened surface due to copper being precipitated by an electrolytic method was used as the negative electrode current collector. The thickness of the electrolytic copper foil before being roughened was 18 μm. The thickness of the electrolytic copper foil after being roughened was 28 μm. The arithmetic average surface roughness Ra of the electrolytic copper foil was measured by using a laser microscope. Ra was 0.6 μm. A silicon thin film was formed by depositing silicon on the electrolytic copper foil by using a sputtering apparatus. An argon gas was used for the sputtering. The pressure of the argon gas was 0.1 Pa. Finally, the silicon thin film was annealed under conditions of 200° C. and 20 hours. Consequently, the negative electrode of Example 1 was obtained. The thickness of the negative electrode active material layer composed of silicon was 10 μm. In this regard, in the present example, the reason the rolled foil having a roughened surface was used as the negative electrode current collector is to increase the contact area between the negative electrode active material layer and the negative electrode current collector so as to maintain a favorable adhesion state between the negative electrode active material layer and the negative electrode current collector during a charge-discharge cycle.

### Production of Solid Electrolyte

In an argon glove box at a dew point of lower than −60° C., Li₂S and P₂S₅ serving as raw material powders were weighed at a molar ratio of Li₂S:P₂S₅=75:25. A mixture was obtained by pulverizing and mixing the raw material powders in a mortar. Thereafter, the mixture was subjected to milling treatment under conditions of 10 hours and 510 rpm by using a planetary ball mill (Model P-7 manufactured by Fritsch). Consequently, a vitreous solid electrolyte was obtained. The resulting solid electrolyte was heat-treated under conditions of 270 degrees and 2 hours in an inert atmosphere. As a result, glass ceramic Li₂S—P₂S₅ serving as a sulfide solid electrolyte was obtained.

### Production of Battery

The steps described below were performed by using the resulting negative electrode and the solid electrolyte. The solid electrolyte in an amount of 80 mg was weighed and placed into an electrically insulating cylinder having a cross-sectional area of the inner diameter portion of 0.7 cm², and pressure molding was performed at 50 MPa. Consequently, an electrolyte layer was produced. Subsequently, the negative electrode punched into the same size as the inner diameter portion of the cylinder was arranged on one surface of the electrolyte layer in the direction in which the negative electrode active material layer was in contact with the electrolyte layer, and pressure forming was performed at 600 MPa. Consequently, a multilayer body composed of the negative electrode and the electrolyte layer was produced. Thereafter, indium metal having a thickness of 200 μm, lithium metal having a thickness of 300 μm, and indium metal having a thickness of 200 μm were arranged in this order on the electrolyte layer of the multilayer body. Consequently, a three-layer multilayer body composed of the negative electrode, the electrolyte layer, and the indium-lithium-indium layer was produced. Next, both ends of the three-layer multilayer body were pinched with stainless steel pins and a pressure of 150 MPa was applied to the three-layer multilayer body with bolts. Consequently, a battery including the negative electrode as a working electrode and the indium-lithium-indium layer as a counter electrode was obtained. Finally, an electrically insulating ferule was used and the interior of an electrically insulating outer cylinder was cut off from the outside atmosphere and sealed so as to produce a battery of Example 1.

### Comparative Example 1

### Production of Negative Electrode

In Comparative example 1, a silicon thin film formed by sputtering was not subjected to annealing. A negative electrode of Comparative example 1 was produced in the manner akin to that of Example 1 except for the above.

A battery of Comparative example 1 was produced by using the resulting the negative electrode in the manner akin to that of Example 1.

### Mass Ratio of Copper Contained in Negative Electrode Active Material Layer

The mass ratio of copper contained in the negative electrode active material layer of Example 1 was determined by using secondary ion mass spectrometry (SIMS). Specifically, with respect to each of the copper element and the silicon element in the negative electrode, the concentration distribution in the thickness direction was obtained by using a secondary ion mass spectrometer (TRIFT2 manufactured by ULVAC-PHI, Inc.). The concentration C1of the copper element and the concentration C2 of the silicon element were calculated from the respective concentration distribution by using the above-described method. It was ascertained from the value of C1/(C1+C2) that copper contained in the negative electrode active material layer of Example 1 was less than or equal to 1% by mass.

### Young's Modulus of Negative Electrode Active Material Layer

Young's modulus of the negative electrode active material layer of each of Example 1 and Comparative example 1 was measured by using a nanoindentation method. Specifically, Young's modulus was measured with respect to 12 arbitrarily selected points on the surface of the negative electrode active material layer by using a nanoindentation apparatus (iNano manufactured by KLA). The indentation depth of the indenter was 10 μm. Of the resulting measurement values, the minimum value and the maximum value were excluded in consideration of measurement errors due to unevenness of the surface of the negative electrode active material layer, and Young's modulus (GPa) was determined by calculating an average value of the resulting 10 points. The results are presented in Table.

### Charge-Discharge Test

Thereafter, the batteries of Example 1 and Comparative example 1 were used, and a charge-discharge test was performed under the following conditions.

A battery was subjected to constant-current charge at room temperature and at a current of 0.2 mA corresponding to a 0.05 C-rate (20-hour rate) relative to the theoretical capacity of the battery. Charge was stopped when the potential of the working electrode reached −0.62 V with reference to the counter electrode. Subsequently, discharge was performed at a current of 0.2 mA, and discharge was stopped when the potential of the working electrode reached 1.40 V with reference to the counter electrode. Consequently, the first discharge capacity (mAh/g) of the battery at a 0.05 C-rate was obtained. The results are presented in Table.

### Measurement of Battery Resistance

The batteries of Example 1 an Comparative example 1 were used, and the electrical resistance was measured under the following conditions.

A battery was subjected to constant-current charge at a current corresponding to a 0.05 C-rate. Charge was stopped when the potential of the working electrode reached −0.62 V with reference to the counter electrode. Thereafter, the interface resistance was measured at 25° C. and a frequency of 10 mHz to 1 MHz by using an alternating current impedance method. Consequently, the interface resistance (Ωcm²) of the battery in a fully charged state was obtained. The results are presented in Table.

### Evaluation of Input Characteristics

The batteries of Example 1 and Comparative example 1 were used, and the input characteristics were evaluated under the following conditions.

A battery was subjected to constant-current charge at 60° C. and at a current corresponding to a 6 C-rate relative to 3,000 mAh/g corresponding to a capacity of about 70% of the theoretical capacity (4,200 mAh/g) of the negative electrode active material (silicon). Charge was stopped when the potential of the working electrode reached −0.62 V with reference to the counter electrode, and the charge capacity at a 6 C-rate was measured. The ratio of the charge capacity at a 6 C-rate to the charge capacity at a 0.05 C-rate was calculated. Consequently, the input characteristics (%) of the battery at the 6 C-rate relative to the 0.05 C-rate were obtained. The results are presented in Table.

### Conduction Endurance Test

The batteries of Example 1 and Comparative example 1 were used, and the conduction endurance test was performed under the following conditions.

A battery was subjected to constant-current charge at a current corresponding to a 0.3 C-rate until the potential of the working electrode reached −0.62 V with reference to the counter electrode. Subsequently, constant-voltage charge was performed at a constant voltage of −0.62 V until the current attenuated to a 0.05 C-rate. Thereafter, discharge to 1.4 V was performed at a current corresponding to a 0.3 C-rate. These operations were assumed to be one cycle, and the cycle was repeated. The discharge capacity when the first cycle was completed and the discharge capacity when the 300th cycle was completed were measured. The ratio of the discharge capacity when the 300th cycle was completed to the discharge capacity when the first cycle was completed was calculated. Consequently, the maintenance factor (%) of the discharge capacity when the 300th cycle was completed was obtained. The results are presented in Table.

TABLE

| | Young's | First discharge | Interface | 6 C charge capacity/ | Discharge capacity |
|---|---|---|---|---|---|
| | modulus | capacity | resistance | 0.05 C charge capacity | maintenance factor |
| | GPa | mAh/g | Ωcm² | % @ 60 deg. | % @ 300 cyc. |
| Example 1 | 20 | 3548 | 2.4 | 75 | 85 |
| Comparative | 30 | 2683 | 9.7 | 0 | 47 |
| example 1 | | | | | |

### Consideration

As presented in Table, Young's modulus of the negative electrode active material layer of Comparative example 1 in the state immediately after the silicon thin film was formed was 30 GPa. On the other hand, Young's modulus of the negative electrode active material layer of Example 1 in which annealing was performed under conditions of 200° C. and 20 hours after the silicon thin film was formed decreased to 20 GPa. It is conjectured that the cause of this is due to a silicon-copper solid solution being formed since copper diffusion on the order of ppm occurred in the negative electrode active material layer as a result of performing annealing at a temperature of lower than or equal to 300° C. after formation of the silicon thin film.

In addition, regarding the battery provided with the negative electrode including the above-described negative electrode active material layer of Example 1, an increase in the first discharge capacity, a decrease in the interface resistance, an improvement in the input characteristics, and an improvement in the discharge capacity maintenance factor were ascertained from the results presented in Table.

### Observation of Cross Section of Negative Electrode

FIG. 3 is an SEM image of a cross section of the negative electrode in a charged state according to Example 1. The SEM image of a cross section in FIG. 3 was obtained from the negative electrode removed by disassembling the battery in the charged state after the conduction endurance test. In the present disclosure, “charged state” denotes a state in which the state of charge is greater than or equal to 50%. The negative electrode of Example 1 included the negative electrode current collector containing copper as a primary component and the negative electrode active material layer having a plurality of columnar bodies containing silicon as a primary component. Young's modulus of the negative electrode active material layer was 20 GPa. The mass ratio of copper contained in the negative electrode active material layer was less than or equal to 1% by mass. As illustrated in FIG. 3, regarding the negative electrode of Example 1, it was observed that, in the charged state, the negative electrode active material layer continued to hold the smooth interface against the electrolyte layer while maintaining a dense columnar structure.

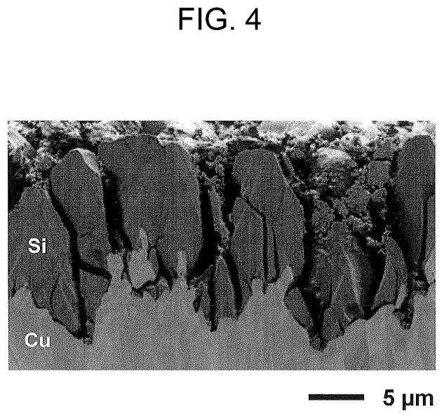

FIG. 4 is an SEM image of a cross section of a negative electrode in a charged state according to Comparative example 1. The SEM image of a cross section in FIG. 4 was obtained from the negative electrode removed by disassembling the battery in the charged state after the conduction endurance test. As illustrated in FIG. 4, in the negative electrode of Comparative example 1, many gaps were present in the negative electrode active material layer. The negative electrode active material layer of Comparative example 1 had lower denseness than the negative electrode active material layer of Example 1. The smoothness of the surface of the negative electrode active material layer of Comparative example 1 was impaired compared with the negative electrode active material layer of the Example 1. It is conjectured that the cause of the battery of Comparative example 1 being inferior to the battery of Example 1 in all of the first discharge capacity, the interface resistance, the input characteristics, and the discharge capacity maintenance factor was due to the contact area between the negative electrode active material layer and the electrolyte layer being decreased.

According to the above-described results, in the battery of Example 1 provided with the negative electrode including the negative electrode active material layer having a Young's modulus decreased to 25 GPa or less, the columnar body readily deformed into a dense columnar structure during the negative electrode expansion process in the first charge. Specifically, a gap between adjacent columnar bodies was decreased, and the surface of the columnar body was smoothened along the surface of the electrolyte layer opposite the negative electrode. Consequently, an interface having a large contact area was formed between the negative electrode active material layer and the electrolyte layer. Accordingly, the negative electrode active material layer could continue to hold the smooth interface against the electrolyte layer while maintaining a dense columnar structure regardless of expansion and shrinkage potentially resulting from charge and discharge thereafter. In addition, regarding the battery of Example 1, since copper contained in the negative electrode active material layer was less than or equal to 1% by mass and was a small amount, the capacity provided to the silicon active material was sufficiently realized. Accordingly, the battery that ensured compatibility between the capacity and the cycle characteristics was realized.

The battery according to the present disclosure is used as, for example, a car-mounted lithium secondary battery.

What is claimed is:

1. A battery comprising:
a positive electrode;
a negative electrode; and
an electrolyte layer located between the positive electrode and the negative electrode,
wherein the negative electrode includes a negative electrode current collector and a negative electrode active material layer located between the negative electrode current collector and the electrolyte layer,
the negative electrode active material layer has a plurality of columnar bodies containing silicon as a primary component, and
a Young's modulus of the negative electrode active material layer is less than or equal to 25 GPa.

2. The battery according to claim 1,
wherein the Young's modulus of the negative electrode active material layer is less than or equal to 20 GPa.

3. The battery according to claim 1,
wherein a thickness of the negative electrode active material layer is less than or equal to 30 μm.

4. The battery according to claim 1,
wherein the negative electrode current collector contains copper as a primary component.

5. The battery according to claim 1,
wherein the negative electrode active material layer contains 1% or less by mass of copper.

6. The battery according to claim 1,
wherein the electrolyte layer contains a solid electrolyte having lithium-ion conductivity.

7. The battery according to claim 6,
wherein the solid electrolyte contains a sulfide solid electrolyte.

8. A battery comprising:
a positive electrode;
a negative electrode; and
an electrolyte layer located between the positive electrode and the negative electrode,
wherein the negative electrode includes a negative electrode current collector and a negative electrode active material layer located between the negative electrode current collector and the electrolyte layer,
the negative electrode active material layer contains silicon and 1% or less by mass of copper, and
a Young's modulus of the negative electrode active material layer is less than or equal to 25 GPa.

9. The battery according to claim 8,
wherein the negative electrode active material layer has a plurality of columnar bodies containing silicon as a primary component.

10. The battery according to claim 8,
wherein the Young's modulus of the negative electrode active material layer is less than or equal to 20 GPa.

11. The battery according to claim 8,
wherein a thickness of the negative electrode active material layer is less than or equal to 30 μm.

12. The battery according to claim 8,
wherein the negative electrode current collector contains copper as a primary component.

13. The battery according to claim 8,
wherein the electrolyte layer contains a solid electrolyte having lithium-ion conductivity.

14. The battery according to claim 13,
wherein the solid electrolyte contains a sulfide solid electrolyte.

15. A method for manufacturing a battery comprising:
depositing silicon on a negative electrode current collector by a gas phase method, and
annealing the deposited silicon at a temperature of lower than or equal to 300° C.

16. The method for manufacturing a battery according to claim 15,
wherein a time of the annealing is greater than or equal to 5 hours and less than or equal to 30 hours.
